(19) United States
(12) Patent Application Publication
(10) Pub. No.: US 2012/0329008 A1
(43) Pub. Date: Dec. 27, 2012

(54) PROCESS FOR MAKING A DENTAL RESTORATION MODEL

(75) Inventors: Laurence Fishman, Venice, CA (US); David A. Richard, Shingle Springs, CA (US)

(73) Assignee: Trident Labs, Inc. d/b/a Trident Dental Laboratories, Hawthorne, CA (US)

(21) Appl. No.: 13/166,683

(22) Filed: Jun. 22, 2011

(51) Int. Cl. A61C 13/00; G06F 17/50

(52) U.S. Cl. 433/172; 700/98

(57) ABSTRACT

A method for making an inverted digital file of digital surface map data and the fabrication of a dental restoration model mold that includes elements of digital scanning of either an impression taken of a patients teeth, a model fabricated from casting or otherwise replicating the patient restoration and adjacent teeth impression, or the manipulation of a digital scan data file of the patient restoration and adjacent sites. The digital data is manipulated by inverting the data contained in the file to precisely create the inverse image of the digital data to render a shell that exactly replicates the surface topography of the restoration site in an inverted manner. A mold fabricated from this inverted data does not require separation, disassembly or distortion to release the positive model cast from the mold.

The present invention relates to the field of dentistry and dental prostheses, and more particularly, to methods used to manufacture dental prostheses.

### BACKGROUND

Conventionally, in the dental field, prostheses and restorations such as crowns, bridges, inlays, and frameworks are used to repair or replace damaged, degraded or missing natural teeth. These crowns, bridges, inlays and other dental restorations are required to fit a patient's teeth, or the reduced topography of the tooth or void created by a dentist in the course of restoration. As can be easily understood, each tooth, or tooth modified by a dentist in preparation for restoration, will have individually different shapes, contours, and fit geometries. Accordingly, the model used in the fabrication of these devices must be precisely produced to replicate the patients tooth and to comfortably fit into the patient's mouth.

Generally, after the dental preparation in which the teeth used for anchoring a prosthesis or other restoration are prepared for receiving a crown or bridge, or where, alternatively, a pin is implanted, an impression of the tooth stump and the surrounding area and jaw is made. This is usually done with silicone sealing compounds, but other materials are also known.

A so-called stone model is then made from the impression, usually by means of a plaster cast. This stone model shows the situation in the patient's mouth positively. Using this stone model, a dental technician fashions a model of the basic structure of the dental prosthesis from wax or from plastic which melts at a low temperature, or hardens in a polymerizing manner. During this process, the dental technician can take the counter occlusion of the other jaw into account.

Traditionally, the model produced by the dental technician is embedded and melted in heat-resistant substances. The basic structure of the prosthesis can then be made by precision casting the device using conventional metal dental alloys. For cosmetic reasons, ceramic or plastic facing may be bonded to the device, at least in the area of the front teeth.

The preparation of the stone models and the shipment of these stone models to a dental laboratory to manufacturer a dental prosthesis or appliance remains a largely manual process.

More recently, advances in three dimensional imaging technologies have produced hand held scanners that are capable of capturing extremely detailed topography data directly from the restoration site in the patient's mouth. Such a scan yields a digitized image of what would normally be acquired by a physical impression of the site.

The advent of computer aided design and computer aided machining, hereafter called CAD/CAM, for dental restorations has made the design of dental restorations and appliances as well as the supporting manufacturing components easier and more available. However, attempts at using the data produced by a scanner to directly manufacture a stone model without using a mold have not been successful. Further, attempts to form a mold from which the stone model is cast have met with limited success, primarily because, up until now, no process has been available for modifying the scanned data set to account for an offset to correct for errors occurring during the inversion process necessary to form a mold.

What has been needed, and heretofore unavailable, is a reliable yet inexpensive process utilizing scanned data to manufacture a mold from which a stone model can be cast. Such a process would eliminate various current intermediate manufacturing processes and the use of skilled labor needed to complete a typical stone model, thus reducing the ultimate cost of manufacture of the dental prosthesis or appliance. The present invention satisfies these and other needs.

### SUMMARY OF THE INVENTION

In its most general aspect, the present invention include systems and methods for manipulating digital data representative of the surface map of the site of a dental restoration that is to be manufactured for a patient such that the data is inverted and used to generate a shell from which a dental restoration or prosthesis may be cast or otherwise formed. Such aspects are advantageous in that a shell can be formed without manipulating the surface map data to compensate for offset or the desired thickness of each of the final shell geometries.

In further aspects, the present invention may used to manufacture or form various restorative design geometries, such as, for example, restoration of a single tooth, multiple teeth, bridges, implants, partial frameworks, abutments, and other restorative dental appliances, restorations or prostheses.

In one aspect, the present invention is embodied in software comprising suitable commands for programming a computer to carry out the commands so as to analyze surface map data and then manipulate the data such that a data file comprising the additive inversion of each data point contained in the surface map data file.

In another aspect, the present invention includes a process for manufacturing a dental restoration model, comprising obtaining data representing the three-dimensional structure of a reconstruction site; analyzing the data for flaws and/or other errors; manipulating the analyzed data to produce a data file containing inverted data; outputting the data file containing the inverted data to a manufacturing process configured to be controlled by the data file containing the inverted data to manufacture a shell; and casting a dental restoration model from the shell.

In an alternative aspect, the manufacturing process is stereo lithography. In yet another alternative aspect, the manufacturing process utilizes CAD/CAM techniques.

In still another aspect, obtaining data representing the three-dimensional structure of a reconstruction site includes scanning at least a portion of a patient's mouth with a scanner configured to provide digital data representing a surface map of the restoration site.

In yet another aspect, the process further comprises storing the digital data representing the surface map of the restoration site in a data memory.

In still another aspect, the present invention includes a method for inverting digital files and creating model shells to be used for the fabrication of dental restoration models or prostheses, comprising: scanning a dental tooth restoration, restoration preparation site, bridges, appliances, or other dental corrective or restorative devices and storing data representative of the scan in a data file; inverting the data in the data file; and forming a shell mold from the inverted data, the shell mold having geometry, anatomy, and morphology of high definitional quality that directly descend from the restoration or prostheses surface.

One alternative aspect includes the method wherein the shell mold is formed using a three dimensional printer. In another alternative aspect, the shell mold is formed using a multi-axis computer controlled machining device.

In still another aspect, the shell mold is formed using a material with a known shrinkage value. In yet another alternative aspect, the material is a rigid material, and in still another alternative aspect, the material is a semi-rigid material.

In a further aspect, the method further comprises fabricating a stone model from the shell mold. In an alternative further aspect, the shell mold includes directly fabricating a stone model from the inverted data.

In a still further aspect, the present invention includes a dental restoration or prosthesis fabricated using the methods and processes of the present invention.

Other features and advantages of the present invention will be come apparent from the following detailed description, taken in conjunction with the accompanying drawings, which illustrate, by way of example, the principles of the invention.

### BRIEF DESCRIPTION OF THE DRAWINGS

FIG. 1 is a cross-sectional view of illustrating placement of a dental bridge on a pair of tooth stumps.

FIG. 2 is a schematic diagram of a digital image capture system.

FIG. 3 is schematic block diagram illustrating an embodiment of the process of the present invention.

FIG. 4 is a perspective view of various examples of positive and negative feature views.

FIG. 5 is top view of a three dimensional surface mesh representative of a data set created by scanning a restoration site.

FIG. 6 is a perspective view of a three dimensional surface pattern created using the three dimensional surface mesh of FIG. 5.

FIG. 7 is a perspective view of a three dimensional mold created by inverting the three dimensional surface pattern of FIG. 6 in accordance with the principles of the present invention.

### DETAILED DESCRIPTION OF THE PREFERRED EMBODIMENTS

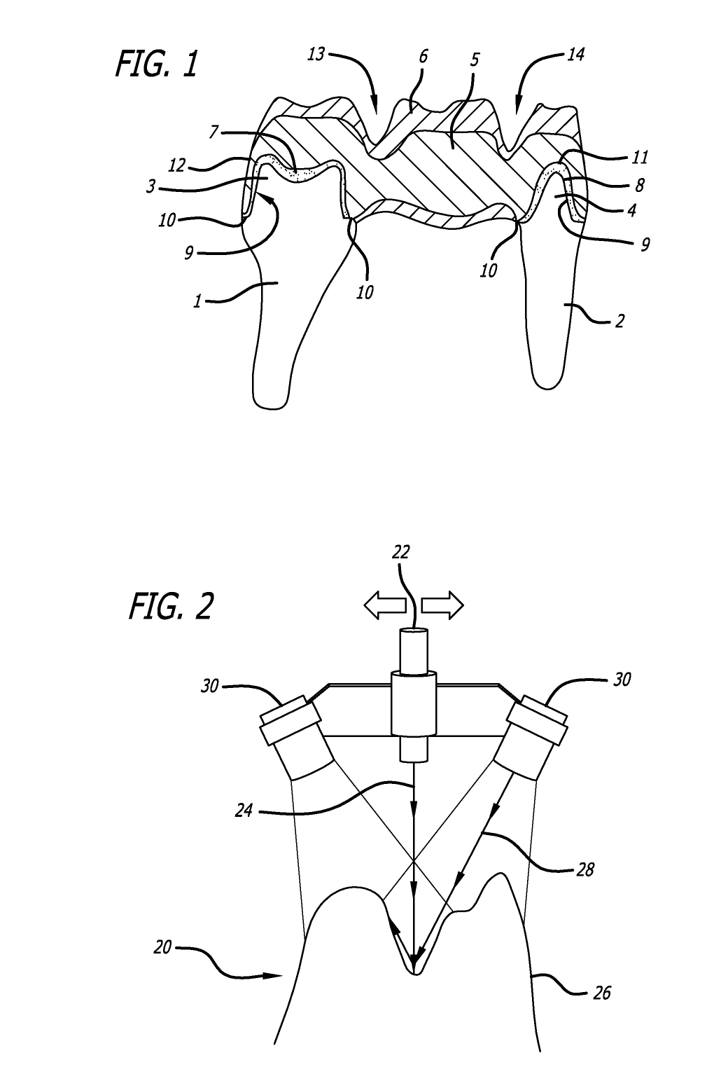

FIG. 1 shows two prepared tooth stumps 1 and 2 which are to be smoothed in their upper areas 3 and 4 for receiving a dental prosthesis. In this case, the dental prosthesis comprises a basic bridge structure 5 which is, in addition, provided with a facing 6 in a conventional manner for producing the visual and masticatory surfaces. The basic bridge structure 5 is fastened in each case to the tooth stumps 1, 2 by means of a layer of a dental cement in the cement gaps 7 and 8.

To produce the dental prosthesis, a master model of the restoration site in which the dental prosthesis is to be placed is first produced. To do this, an impression corresponding to the negative form of the dental structure is first taken. This impression is typically used to cast a positive model. Various methods know in the art are used for this process. However, all of the current techniques rely upon a great deal of manual work on the finished structure utilizing skilled dental technicians.

More recently, highly accurate scanning equipment have been used to provide a data set that includes all of the detail formerly obtained from the impression of a patient's mouth. This data set can then be used to make the stone model of the restoration prosthesis.

FIG. 2 illustrates a typical digital capture system used to scan a restoration location and produce a data set that can then be used to manufacture a model. In FIG. 2, a laser digitize 20 includes a laser camera or LED scanner 22 which provide a light beam 24 which is focused on the restoration location 26. Alternatively, the laser camera or scanner 22 may also be focused upon an impression, and in particular, it may be focused on an impression that has been mounted on a rotating stage. The laser focused on the restoration location or impression is reflected by the topography of the restoration location or impression and the reflected laser light 28 is collected by sensor or sensors 30. The laser 22 or sensor 30 can be moved across the restoration location or impression under either manual or computer control to build a three-dimensional data set containing data related to the location and elevation of surface features present at the restoration location or impression. In this manner a three-dimensional digital representation of the surface of the restoration location or impression can be acquired and stored in an appropriate memory. Alternatively, the scanned image may also be displayed on a monitor (not shown).

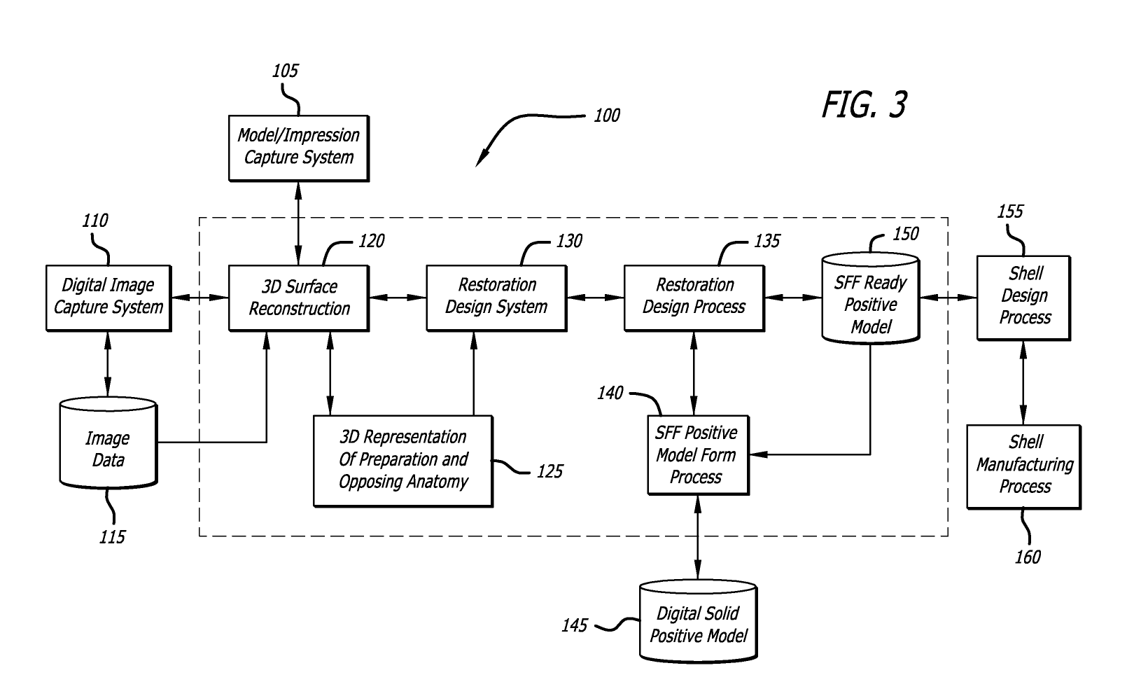

FIG. 3 is a schematic representation of the various steps of one embodiment of the present invention that are utilized to form a prosthesis. Using these steps, it is possible to produce an inverted replica mold possessing the high definition needed to produce a solid stone model.

### DEFINITIONS

“Model” means a three-dimensional representation of an object to be replicated into a representation of a restoration site. A model has a “master” surface from which corresponding fit surfaces on or in a dental restoration descend.

“Shell” means an object that is an inverted, surface-by-surface imitation of a model, digital image, or digital files containing three dimensional Cartesian coordinate system code.

“Negative image” means an inverse imitation of the mode, not a reciprocal or negative image.

“Mold” means the same as “shell.”

Returning again to FIG. 2, data representative of the current condition of the restoration site is obtained either by taking an impression of the site, as in box 105, or by scanning the restoration site to digitally capture an image of the site, as in box 110. Optionally, the digital data obtained in box 110 may be stored in an image file or other similar memory in box 115.

The information and/or data obtained using the processes of boxes 105 or 110 are then uploaded into a computer operating under the control of suitable software to provide a three-dimensional reconstruction of the surface map of the restoration site, as in box 120. Alternatively, a three-dimensional map of the opposing anatomy of the patient's mouth may also be generated in box 125.

The three dimensional reconstruction is then reviewed to correct for missing or flawed data in boxes 130, 135, which, although shown as separate processes, may be the same process. The data is then ready to be communicated to either a stereo lithography process (STL) or solid free form (SFF) process to form the stone model.

Previously, such process as indicated by boxes 140, 145 and 150 have been used, but have been found undesirable, due to inaccuracies of the resulting model that occur because the data used to generate the models directly do not accurately reflect all of the subtle features and fitments necessary to make a prosthesis that fits well and is comfortable in the patient's mouth. It is just these precise adjustments that were manually created by highly skilled dental technicians.

The inventors of the various embodiments of the present invention have discovered a method of inverting the digital data representing three dimensional Cartesian coordinates of the various features and dimensions of the restoration site generated at boxes 110 or 120, 125 to produce a shell or mold to be used for the fabrication of the dental restoration or prosthesis.

The process of the various embodiments of the invention is incorporated into software that is configured to control either a custom made computer, or to reconfigure a general computer, to carry out the programming commands of the software to manipulate the digital data to invert the digital reconstruction data so that the inverted data can be used to fabricate a shell from which an accurate stone model of the reconstruction site can be manufactured.

Various attributes that can be used during the inverting process are non-uniform rational basis splines (nurbs), or Volumetric Picture Element (voxel) based models which use a combination of voxels and non-uniform rational basis splines (nurbs). Although voxels have been found to be advantageous in several embodiments of the present invention, other data representations can also be used, such as point clouds, polymeshes, the aforementioned nurbs, and others in addition to or in place of voxel representation.

As described above, the shell design process of box 155 provides for an inversion of the three dimensional data. It should be understood that by inversion, it is meant the additive inverse, not the multiplicative inverse. For example, the additive inverse of 2 is −2. A multiplicative inverse, or reciprocal will not provide the same result. For example, the multiplicative inverse of 2 is ½.

In one embodiment of the present invention, the software embodying methods of the present invention controls a computer to apply appropriate functions to each data point of the data file representing the three dimensional Cartesian coordinates of the restoration site. As described above, this process inverts the data in the data file. For example:

f(f⁻¹(x))=x and Equation 1

f⁻¹(f(x))=x Equ. 2

The embodiments of the present invention utilize algorithms that are programmed using software code to control the operation of a processor. The programming causes the processor to carry out the mathematical functions of the algorithms to process the data in the data file, resulting in a set of inverted three-dimensional data that can be used to directly create a model of the restoration site.

One example of a suitable algorithm that can be used is the Pineda Algorithm, wherein the value of an edge functions at a pixel is computed incrementally, with a single addition, from the value at a previous pixel. For an edge located between (Xᵢ₋₁, Yᵢ₋₁) and (Xᵢ, Yᵢ), the edge function Eᵢ is computed as:

dXᵢ=Xᵢ−Xᵢ₋₁ Equ: 3

dYᵢ=Yᵢ−Yᵢ₋₁ Equ. 4

Eᵢ(X,Y)=(X−Xᵢ)dXᵢ−(Y−Yᵢ)dYᵢ Equ. 5

Similar equations are used to compute the coefficients for linear functions to interpolate parameters across the triangle, such as, for example, color, texture coordinates, positive to negative and the like. Although not visible in these equations, one skilled in the art will understand that the equations also include the divisions required to project each of the tree vertices of an edge onto a video screen or monitor in either a positive or negative interpolation and another division required to normalize the parameter interpolation equations.

Another example of an algorithm that can be used in various embodiments of the present invention to produce an inverted data set that can be used to manufacture a model is an algorithm based on the Catmull-Clark scheme to generate subdivision offset surfaces. For example, where r=r(u,v) defines a surface, the locus of the points which are at a constant distance d along the normal from the generator surface r=r(u,v) defines an offset or parallel surface. The offset is calculated:

\hat{r}(u,v)=r(u,v)+d·n(u,v) Equ. 6

Where d may be a positive or negative real number, n(u,v) is a unit normal vector of r(u,v), that is:

$$\begin{matrix}n ( u , v ) = \frac{{r}_{u} ( u , v ) \times {r}_{v} ( u , v )}{‖ {r}_{u} ( u , v ) \times {r}_{v} ( u , v ) ‖} & Equ . 7 \\ Where \text{:} & \\ {r}_{u} ( u , v ) = \frac{\partial r ( u , v )}{\partial u} & Equ . 8 \\ {r}_{v} ( u , v ) = \frac{\partial r ( u , v )}{\partial v} & Equ . 9 \\ and & \\ ‖ {r}_{u} ( u , v ) \times {r}_{v} ( u , v ) ‖ \neq 0 & Equ . 10\end{matrix}$$

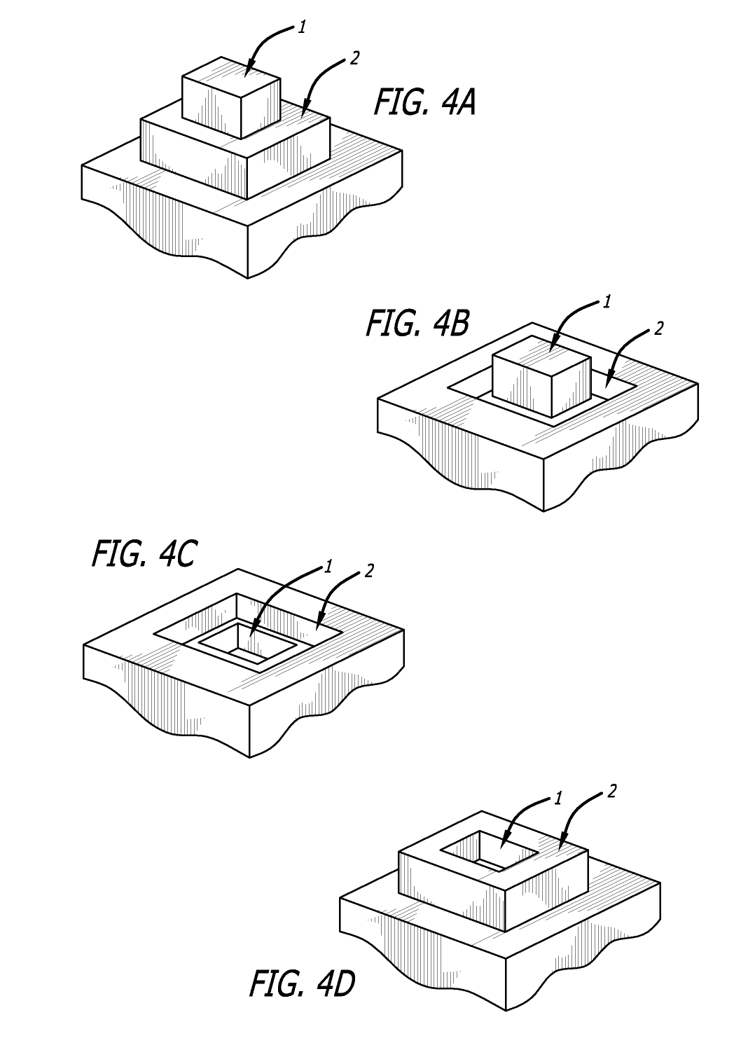

In a preferred embodiment, a modified Catmull-Clark algorithm is used to compute equivalent edge functions and parameter interpolation functions using 2D homogeneous screen coordinates without computing the actual screen coordinates. FIG. 4 illustrates these concepts.

As can be seen in FIG. 4a, for positive features, face normals point away from the feature volume enclosed. Conversely, for negative features, the face normals point into the feature volume enclosed. This can be seen in FIG. 4b, where feature (2) is a negative feature, and now points into the volume it encloses. FIGS. 4c and 4d show other combinations of positive and negative features.

The algorithm for mapping the mode to another feature model, as is done by various embodiments of the present invention, is based on classification of faces of features in the model and the splitting of a solid by a surface. Such a mapping process may, in some embodiments, involve the step of classifying faces forming the features in the input model with respect to each other, deriving a dependency relations amongst the features in the input model and constructing a feature relationship table. The next step involves using the feature relationship to cluster features and to resolve any interactions between features. Finally, algorithms for splitting of a solid by a surface are used to determine the volumes corresponding to the features in the target domain. Multiple feature sets can be obtained by varying the sequence of faces used for clipping.

The present invention cannot be described as a mirror imaged design as if one looks in a mirror, one's image reverses. Reciprocal implies an equality. To reciprocate a smile means to smile back. While inverse implies an opposite. To invert a smile means to frown.

One advantage of the various embodiments of the present invention is that those embodiments do not require manipulating the surface map data to compensate for offset or the desired thickness of each of the final shell geometries, as is required using prior art methods. Moreover, the ability to manufacture a shell using the embodiments of the present invention is that the removal of the model from the shell does not require separation, distortion or disassembly of the shell. Further, it is not necessary to create a frangible or weakened area of the shell to facilitate removal of the cast model. Additionally, a shell manufactured using the embodiments of the present invention can be used to make a multitude of un-distorted replica castings from the same shell.

In a preferred embodiment, the original digital data should be meshed and stitched to remove all data voids, unwanted geometry holes, or missing detail prior to processing the data through the shell program for inversion. Once the inversion process is complete, the inverted date is then downloaded, typically using a STL data format, to a stereo lithography system capable of accepting the file and producing the shell in box 160. Alternately, the digitally inverted data file can be transmitted to a computer controlled machining center using the inverted file data download to machine the shell.

Where stereo lithography is used to manufacture the shell, a file containing the inverted data produced in the process of box 155 is communicated to equipment designed to create a model from the data file. The equipment may generate a “slice file” from the inverted data file, which is then used to manufacture the model in layers, laying down subsequent layers until the entire model is formed. Such layers may, for example, be on the order of 0.002 inch to 0.008 inch thick (50 to 200 microns). The slice file then is input into the stereo lithography machine. The machine essentially “prints” each layer by exposing a layer of resin to a light source, such as a laser or UV lamp, to cure the resin in accordance with the data in the slice file. In this manner, a three-dimensional shell is generated.

Alternatively, as described above, the inverted data file generated at box 155 may be provided to equipment suitable for manufacturing solid free forms. Such methods and equipment include systems such as Computer Aided Design/Computer Aided Manufacturing (CAD/CAM) systems well known in the art.

The application of stereo lithography and other techniques include, but are not limited to, for example, 3D printed resin, wax or other viscous materials, selective area laser deposition or selective layer sintering, fused deposition modeling, laser or UV cured 3D layering within a resin bath, laminated object manufacturing (LOM) and other methods using the principles of stereo lithography (SLA) and photo-stereo lithography. Examples of such technology and methods are described in, but not limited to, U.S. Pat. Nos. 5,700,289, 5,518,680, 5,490,962, 5,490,882, 5,387,380, 5,340,656, 5,204,055, and 4,672,032, each of which is hereby incorporated herein in their entirety. Moreover, suitable prototyping machines manufactured by; for example, but not limited to, 3D Systems, EnvisionTEC GmbH, Objet Geometries Ltd., and others utilizing technology compatible with the various embodiments of the present invention.

### Example

The following is an example of use of an embodiment of the present invention to scan an impression and generate a data set of inverted date for use in generating a model.

A silicone impression of a bicuspid restoration site and opposing teeth anatomical model was trimmed and coated with a layer of glare free substance. The trimmed coated impression was placed on a revolving support in a 3Shape Model D-250 digitizing scanner available from 3Shape Dental systems, Copenhagen, Denmark. After mounting on the support fixture, additional glare free substance was added to assure that no imperfections were evident in the coating coverage.

The impression was scanned by the digitizing scanner at a scanning speed of 100 points per second with each point spaced at 0.0025 of an inch from the adjacent point. A step over scanning preset distance of 0.005 inches was used during the scanning process. According to the literature provided by the manufacture, the laser beam of the digitizing scanner had a waist diameter of 0.00275 inches, and a system accuracy of plus or minus 0.00075 inches. Actual scanning time for the impression, preparation and opposing side, was 3.5 minutes.

The digitized data was collected in a computer file with a case number address on a 100 gigabyte hard drive. The software output extension was .STL, a machine readable language. The 3Shape DentalDesigner ScanIt CAD software provided the digital input translation. The translated data was edited within the CAD/CAM system and a three dimensional model displayed of the impression on the video monitor of the scanner system. The translated values of the computer software edited data were also stored in the case file.

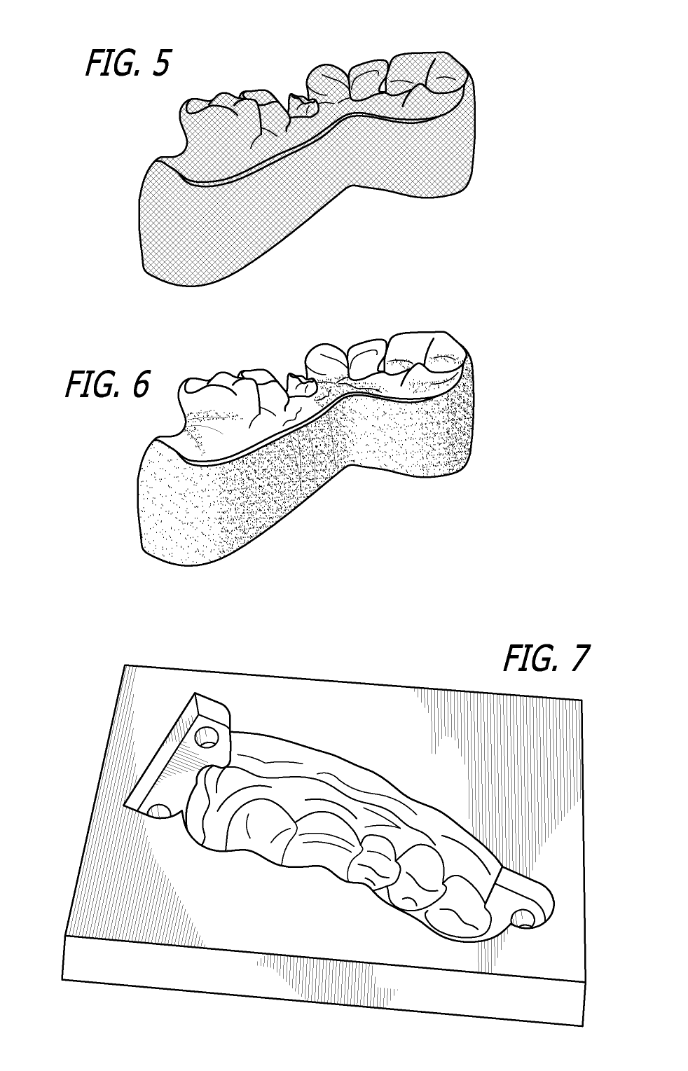

FIG. 5 show a three dimensional top view of a surface mesh created using the data stored in the case file. This surface mesh is a representation of the restoration site, and can be inspected for anomalies. The data used to create the mesh is then transformed by the computer software to a three dimensional surface pattern, such as is shown in FIG. 6.

The surface pattern shown in FIG. 6 was then examined by the operator for size, shape, anomalies, and overall anatomical attributes of the digital image to assure that it possessed the qualities of definition, morphology, integrity of surface, and completeness to support the fabrication of the restoration and complementary shell mold. If the operator determined that the integrity and quality of the digitized scan was not sufficient to support the restoration or shell model fabrication, the operator would inspect the uniformity of coverage of the glare free substance and; if acceptable, would reposition the impression in the holding fixture and re-insert the impression into the scanner and re-scan the impression.

Once an acceptable digital representation of the model or impression being scanned is achieved, the operator once again inspects the digital image as described above, following a pre-established post scan regimen. If the scan is found to be acceptable, the operator closes the ScanIt software and exports the scan file for conversion, using an embodiment of the present invention, to an inverted shell of the scanned impression, model, or appliance.

The conversion process requires the operator to validate the integrity of the digital scanned data, perform repairs if necessary to close or replace data points in none critical areas of the digital image, convert the file from its native extension to .stl, add non-anatomical detail to establish uniform planes to the digital image, and trim the digital image to reduce the non-anatomical profile.

If the surface patter is found to be acceptable, or once adjustments have been made to the data set to correct anomalies or other problems with the surface pattern, and the operator is satisfied with the integrity and support geometry requirements of the data for the present invention, the operators commands the inverting software of the present invention to perform the invert process. This process results in the data set being inverted in a controlled fashion to produce a shell mold, such as that represented by the drawing of FIG. 7. This inverted mold includes compensation for geometrical adjustments necessary to directly mold an accurate stone model of the restoration site. When the inversion process has been completed, the operator transmits the file to one of the aforementioned manufacturing modalities for the creation of the shell mold or model.

While several particular embodiments of the present invention have been illustrated and described, it will be apparent that various modifications can be made without departing the spirit and scope of the invention. Furthermore, it is not intended that the invention be limited, except as by the appended claims.

We claim:

1. A process for manufacturing a dental restoration model, comprising:
obtaining data representing the three-dimensional structure of a reconstruction site;
analyzing the data for flaws and/or other errors;
manipulating the analyzed data to produce a data file containing inverted data;
outputting the data file containing the inverted data to a manufacturing process configured to be controlled by the data file containing the inverted date to manufacture a shell; and
casting a dental restoration model from the shell.

2. The process of claim 1, wherein the manufacturing process is stereo lithography.

3. The process of claim 1, wherein the manufacturing process utilizes CAD/CAM techniques.

4. The process of claim 1, wherein obtaining data representing the three-dimensional structure of a reconstruction site includes scanning at least a portion of a patient's mouth with a scanner configured to provide digital data representing a surface map of the restoration site.

5. The process of claim 4, further comprising storing the digital data representing the surface map of the restoration site in a memory.

6. A dental restoration or prosthesis manufactured using the process of claim 1.

7. A method for inverting digital files and creating model shells to be used for the fabrication of dental restoration models or prostheses, comprising:
scanning a dental tooth restoration, restoration preparation site, bridges, appliances, or other dental corrective or restorative devices and storing data representative of the scan in a data file;
inverting the data in the data file; and
forming a shell mold from the inverted data, the shell mold having geometry, anatomy, and morphology of high definitional quality that directly descend from the restoration or prostheses surface.

8. The method of claim 7, wherein the shell mold is formed using a three dimensional printer.

9. The method of claim 7, wherein the shell mold is formed using a multi-axis computer controlled machining device.

10. The method of claim 7, wherein the shell mold is formed using a material with a known shrinkage value.

11. The method of claim 10, wherein the material is a rigid material.

12. The method of claim 10, wherein the material is a semi-rigid material.

13. The method of claim 7, further comprising fabricating a stone model from the shell mold.

14. The method of claim 7, wherein forming the shell mold includes directly fabricating a stone model from the inverted data.

15. A dental restoration or prosthesis fabricated using the method of claim 7.
